(19) United States
(12) Patent Application Publication
(10) Pub. No.: US 2007/0013550 A1
(43) Pub. Date: Jan. 18, 2007

(54) Apparatus and method for integrating an optical navigation mechanism with non-optical sensor-based presence detector

(76) Inventors: Tong Xie, San Jose, CA (US); Michael J. Brosnan, Fremont, CA (US)

Correspondence Address: AVAGO TECHNOLOGIES, LTD., P.O. BOX 1920, DENVER, CO, 80201-1920, US

(21) Appl. No.: 11/181,042

(22) Filed: Jul. 13, 2005

(51) Int. Cl. G08G 1/00

(52) U.S. Cl. 340/901

(57) ABSTRACT

An apparatus and method for integrating an optical navigation mechanism with non-optical sensor are described. At least one optical sensor is provided that detects light and converts the detected light into a corresponding electric signal. An optical navigation mechanism that employs the output of the optical sensor to provide user-controllable cursor navigation is also included. The optical navigation mechanism has a power saving state and an operation state. A non-optical sensor is provided that detects the presence or absence of an object in the vicinity of the non-optical sensor and selectively generates a present signal. A power saving mechanism is coupled to the non-optical sensor and receives the present signal and responsive thereto causes the optical navigation mechanism to transition from the power saving state to the operation state or from the operation state to a power saving state.

### BACKGROUND OF THE INVENTION

Cursor control devices or cursor pointing devices are important components in electronic systems and allow a user to control a cursor and perform other user functions, such as selecting a function. For example, a mechanical mouse was utilized for this purpose. In recent years, the mechanical mouse has been largely replaced by the optical mouse or optical navigation device.

The optical navigation device provides several advantages over other cursor control approaches. First, the optical navigation device is often more responsive than mechanical cursor pointing or control devices. Second, the optical navigation device is often more accurate than the mechanical mouse. Third, the optical navigation device is more reliable than the mechanical mouse since there are fewer mechanical parts that wear out over time.

However, one drawback of the optical navigation device is that it tends to consume more power than the other approaches. For example, components, such as the illumination source (e.g., light source), optical sensor array, and signal processing circuits tend to consume a significant amount of electrical power. Consequently, one area of current interest in making optical navigation device a viable option for portable electronic equipment where power is limited by battery life is the development and implementation of power saving algorithms. By solving or overcoming the barrier of energy consumption for optical navigation device, the technology will be one step closer to enabling optical navigation device to be utilized in portable electronic devices (e.g., handsets).

One approach to save power or reduce the amount of power consumed in the electronic device that utilizes an optical navigation device is to cause the optical navigation device to enter a “sleep” mode when it is determined that the electronic device is unattended or not in use. During “sleep” mode, components of the optical navigation device are operated with reduced power (e.g., with reduced duty cycle) in order to keep power consumption to a minimum and yet are able “wake up” to full function as quickly as possible when user activation is detected. For example, the light source, optical sensor array, and other signal processing circuits may be placed in the “sleep” mode.

For example, changes in ambient light can trigger the optical sensor out of sleep mode. When applied to a handset, for example, where the light conditions change, the handset may be inadvertently be brought out of sleep mode, when in fact, the user has no intention of using the device. Unfortunately, these false positives drain the battery life of the electronic device and are thus not desirable. Similarly, a successful approach enables a user to reliably activate the electronic device or to bring the device out of sleep mode. Consequently, a more reliable mechanism for determining when an electronic device is unattended is needed.

Based on the foregoing, there remains a need for a method and apparatus that reliably determines when an electronic device is unattended and that overcomes the disadvantages set forth previously.

### SUMMARY OF THE INVENTION

According to one embodiment of the present invention, an apparatus and method for integrating an optical navigation mechanism with non-optical sensor are described. At least one optical sensor is provided that detects light and converts the detected light into a corresponding electric signal. An optical navigation mechanism that employs the output of the optical sensor to provide user-controllable cursor navigation is also included. The optical navigation mechanism has a power saving state and an operation state. A non-optical sensor is provided that detects the presence or absence of an object in the vicinity of the non-optical sensor and selectively generates a present signal. A power saving mechanism is coupled to the non-optical sensor and receives the present signal and responsive thereto causes the optical navigation mechanism to transition from the power saving state to the operation state or from the operation state to a power saving state.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a portable electronic device that includes an optical navigation mechanism integrated with a non-optical sensor according to one embodiment of the invention.

FIG. 2 illustrates a state diagram for the presence determination mechanism of FIG. 1 according to one embodiment of the invention.

FIG. 3 illustrates a state diagram for the presence determination mechanism of FIG. 1 according to second embodiment of the invention.

FIG. 4 is a block diagram illustrating a non-optical sensor array that is integrated in an optical sensor array according to a one embodiment of the invention.

FIG. 5 is a flowchart illustrating a method performed by the presence detector according to a one embodiment of the invention.

FIG. 6 illustrates a non-optical sensor according to one embodiment of the invention.

FIG. 7 illustrates a non-optical sensor according to another embodiment of the invention.

FIG. 8 illustrates a non-optical sensor integrated with a button of an electronic device according to a one embodiment of the invention.

### DETAILED DESCRIPTION

An apparatus and method for integrating an optical navigation mechanism with non-optical sensor-based presence detector are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Portable Electronic Device 100

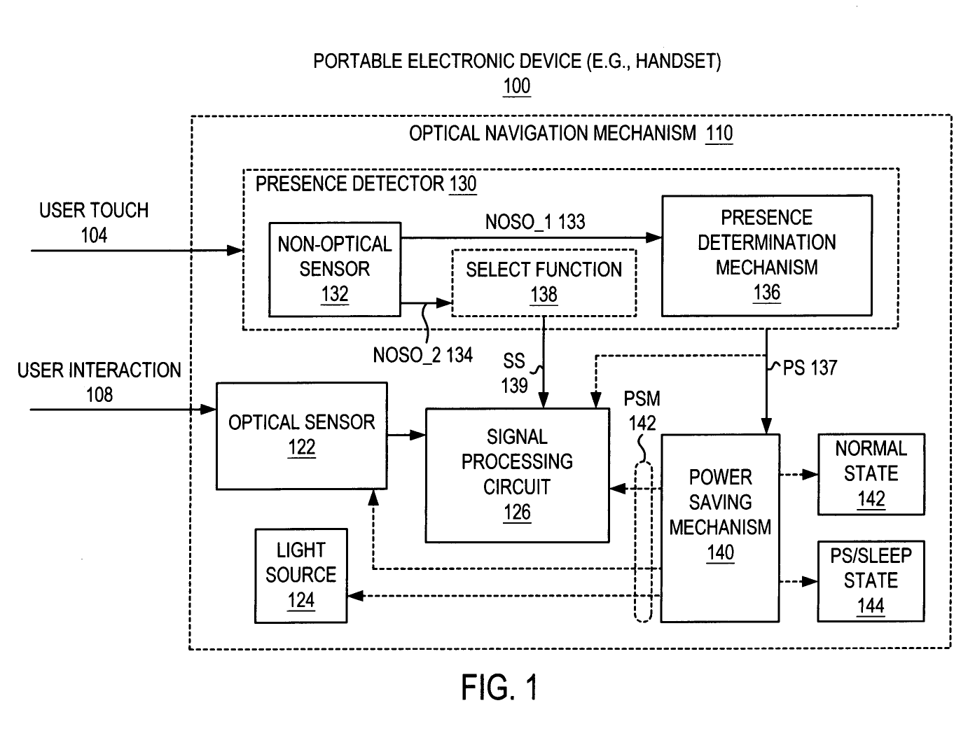

FIG. 1 illustrates a portable electronic device 100 that includes an optical navigation mechanism 110 with integrated non-optical sensor-based presence detector 130 according to one embodiment of the invention. The portable electronic device 100 can be, for example, a handset for cellular telephone communications or other portable electronics that utilizes optical sensor technology (e.g., optical cursor control and navigation).

The electronic device 100 includes an optical navigation mechanism 110 that provides a user with cursor pointing and control based on an optical sensor 122. The optical navigation mechanism 110 according to one embodiment of the invention includes a non-optical sensor based presence detector 130 that detects a user's presence 104, such as a user's touch (e.g., contact with the surface of a user's finger).

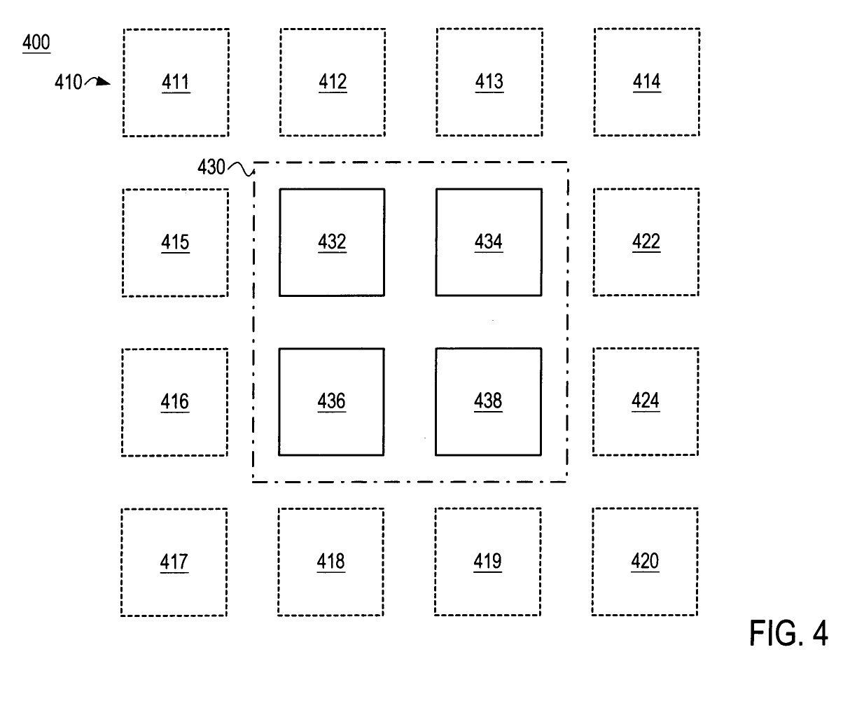

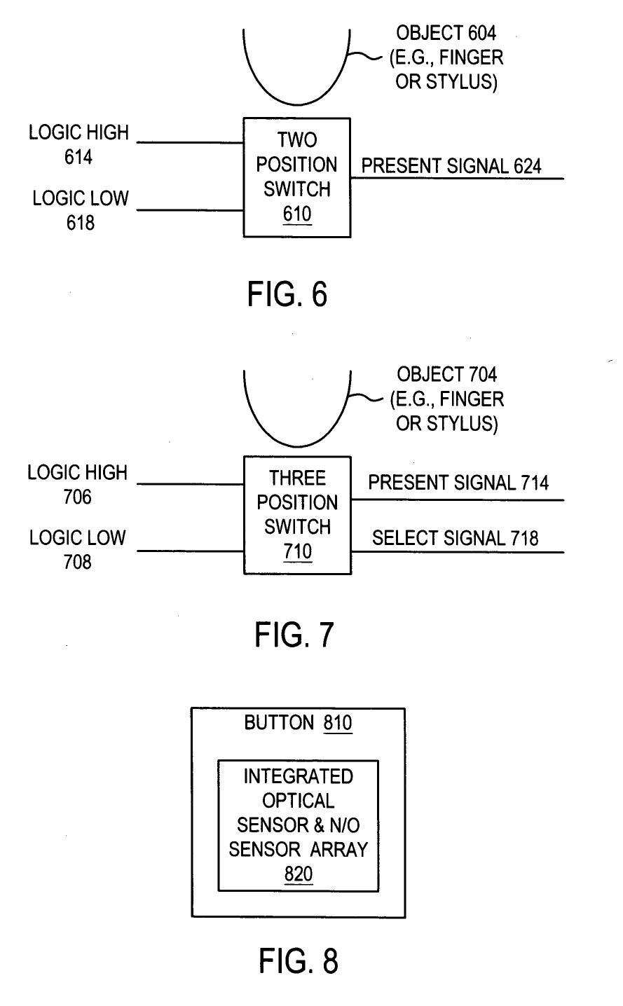

The presence detector 130 includes a non-optical sensor 132 that employs non-optical methods to detect the presence or absence of a user. The non-optical sensor 132 generates a first output signal 133 (referred to herein also as non-optical sensor output_1 (NOSO_1) 133) and a second output signal 134 (referred to herein also as non-optical sensor output_2 (NOSO_2) 134). The non-optical sensor 132 can include, but is not limited to, a weight based sensor, a capacitor based sensor, or other sensor that is capable of detecting when an object makes contact with or comes in the proximity of the optical mouse. The presence of a user's hand near or in the vicinity of the sensor can, for example, change an electric field and hence the capacitance in the case where a capacitor-based sensor is utilized. The non-optical sensor 132 can be implemented with a non-optical sensor array that includes one or more non-optical sensors that are arranged in a predetermined fashion (e.g., in rows and columns) and is described in greater detail hereinafter with reference to FIG. 4. Exemplary types of non-optical sensors 132 are described with reference to FIGS. 6-8.

The presence detector 130 also includes a presence determination mechanism 136 that receives the first output signal (NOSO_1 133) and a select function circuit 138 that receives the second output signal (NOSO_2 134). The presence determination mechanism 136 selectively asserts a present signal (PS 137) based on the first output of the non-optical sensor 132. For example, when the NOSO_1 133 is asserted indicating presence of a predetermined object, the presence determination mechanism 136 asserts the present signal (PS) 137 or causes the PS 137 to have a logic high level. When the NOSO_1 133 is not asserted, indicating absence of a predetermined object, the presence determination mechanism 136 de-asserts the present signal (PS) 137 or causes the PS 137 to have a logic low level.

The present signal 137 is provided to a power saving mechanism 140 that reduces the amount of power expended by the optical navigation mechanism 110. For example, the power saving mechanism 140 generates a power saving mode signal (PSMS) 142 that may be provided to the optical sensor 122, the light source 124, and the signal processing circuit 126. The PSMS 142 is utilized to reduce the power expenditure of various components of the optical navigation mechanism 110. Alternatively, the power saving mechanism 140 can be integrated with the signal processing circuit 126. In this case, the present signal 137 may be provided directly to the signal processing circuit 126 to trigger a reduction of power expenditure.

The optical navigation mechanism 110 optionally includes a select function circuit 138 that is coupled to the non-optical sensor 132 to receive the NOSO_2 134. Based on NOSO_1 134, the selection function circuit generates a select signal (SS) 139 and provides the SS 139 to the signal processing circuit 126. The SS 139 is then utilized by the signal processing circuit 126 to process a particular function selected by the user.

The power saving mechanism 140 also selectively causes the optical navigation mechanism 110 to transition from a normal operating state 142 or mode into a power-saving state 144 or sleep mode or from a power-saving state 144 or sleep mode to the normal operating state 142 or mode based on the present signal 137.

The optical navigation mechanism 110 includes a light source 124, an optical sensor 122, a signal processing circuit 126, and the power saving mechanism 140. The light source 124 provides light or illumination for the optical navigation mechanism 110. Light reflected back from an object (e.g., the surface of a user's finger) is then received by the optical sensor 122. The optical navigation mechanism 110 can be an optical mouse or optical joystick or other cursor pointing or cursor control mechanism that uses light reflected from an object (e.g., a user's finger) to provide cursor control. The optical sensor 122 can be implemented with an optical sensor array that includes one or more optical sensors that are arranged in a predetermined fashion (e.g., in rows and columns) and is described in greater detail hereinafter with reference to FIG. 4.

The signals corresponding to the received light are then provided to the signal processing circuit 126 that performs signal processing on these signals to provide cursor control. The construction and operation of components 122, 124, and 126 are well-known to those of ordinary skill in the art and are not described in further detail herein.

It is noted that the non-optical sensor 132 may be implemented separately from the optical sensor 122, implemented adjacent to the optical sensor 122, or integrated with the optical sensor 122. For example, in one embodiment illustrated in FIG. 4, the non-optical sensor 132 may be implemented in the center of an array of the optical sensors.

The power saving mechanism 140 selectively causes the optical navigation mechanism 110 to enter into a sleep state (or power-saving state) 144 from a normal operation state 142. During sleep state 144, the power saving mechanism 140 reduces or otherwise limits the amount of power that is provided to selected components of the optical navigation mechanism 110. In one embodiment, the power saving mechanism 140 reduces the amount of power that is provided to the optical sensor 122, light source 124, and the signal processing circuit 126.

For example, one approach to save power or reduce the amount of power consumed in the electronic device 100 that utilizes the optical navigation mechanism 110 is to cause the optical navigation mechanism 110 to enter a “sleep” mode when it is determined that the electronic device 100 is unattended or not in use. During “sleep” mode, components of the optical navigation mechanism 110 are operated with reduced power (e.g., with reduced duty cycle) in order to keep power consumption to a minimum and yet be able to “wake up” to full function as quickly as possible when user activation is detected. For example, the light source 124, optical sensor array 122, and other signal processing circuits 126 may be placed in the “sleep” mode.

### STATE DIAGRAM FOR FIRST EXEMPLARY EMBODIMENT

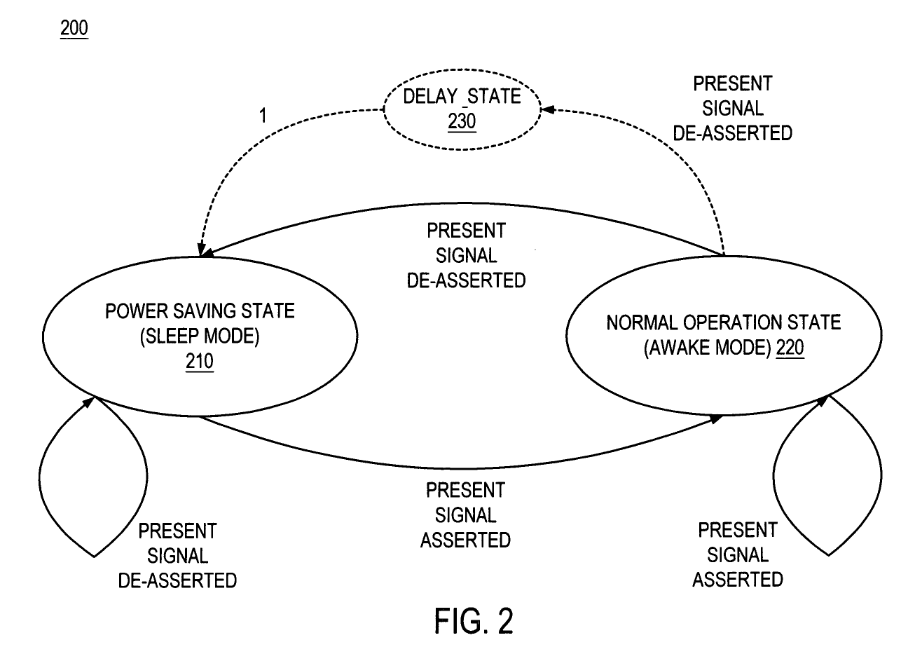

FIG. 2 illustrates a state diagram 200 for the presence determination mechanism of FIG. 1 according to one embodiment of the invention. The state diagram 200 includes a power saving state 210 (also referred to herein as a sleep mode) and a normal operation state 220 (also referred to herein as an awake mode). The optical navigation mechanism 110 remains in normal operation state 220 as long as the present signal is asserted (e.g., when the present signal remains at a logic high level). Similarly, the optical navigation mechanism 110 remains in the power saving state 210 as long as the present signal is de-asserted (e.g., when the present signal remains at a logic low level). The optical navigation mechanism 110 transitions from the power saving state 210 to the normal operation state 220 when the present signal is asserted (e.g., when the present signal changes from a low logic level to a high logic level). Also, the optical navigation mechanism 110 transitions from the normal operation state 220 to the power saving state 210 when the present signal is de-asserted (e.g., when the present signal changes from a high logic level to a low logic level).

The state diagram 200 also optionally includes a delay state 230. For example, when the present signal is de-asserted (e.g., when the present signal changes from a logic high level to a logic low level), the optical navigation mechanism 110 can transition from the normal operation state 220 to the delay state 230 instead of directly to the power saving state 210. In the delay state 230, a predetermined amount of time passes to ensure, for example, that the user is no longer interacting with the electronic device. After the predetermined time has elapsed, the optical navigation mechanism 110 transitions automatically to the power saving state 210.

### STATE DIAGRAM FOR SECOND EXEMPLARY EMBODIMENT

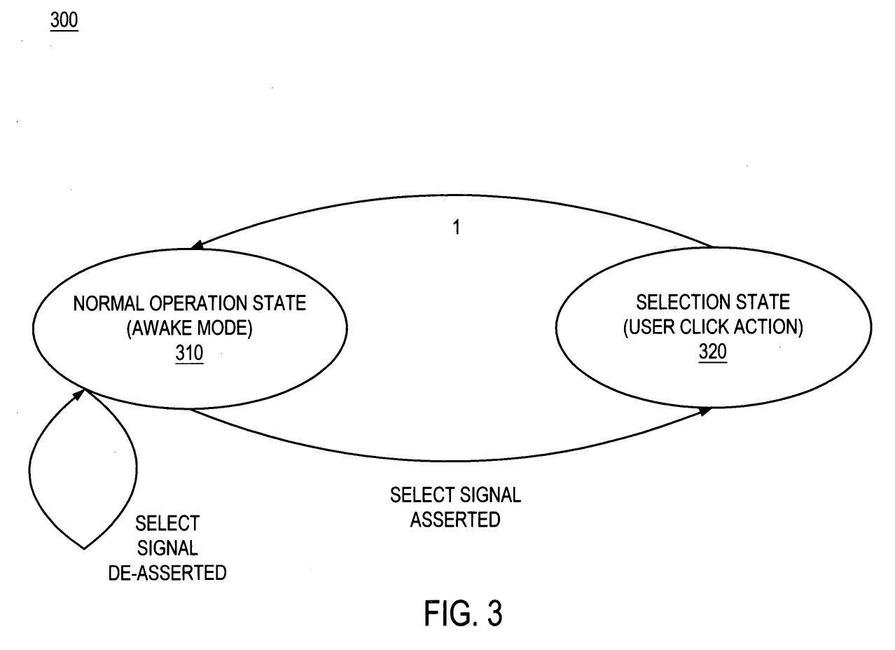

FIG. 3 illustrates a state diagram 300 for the presence determination mechanism of FIG. 1 according to second embodiment of the invention. The state diagram 300 includes a normal operation state 310 (also referred to herein as an wake mode) and a selection state 320 (also referred to as a user click/action mode). The optical navigation mechanism 110 remains in normal operation state 310 as long as the select signal is not asserted (e.g., when the select signal remains at a logic low level). Similarly, the optical navigation mechanism 110 remains in the selection state 320 as long as the select signal is asserted (e.g., when the select signal remains at a logic high level). The optical navigation mechanism 110 transitions from the normal operation state 310 to the selection state 320 when the select signal is asserted (e.g., when the select signal changes from a low logic level to a high logic level). Also, the optical navigation mechanism 110 automatically transitions from the selection state 320 to the normal operation state 310 after the select signal is provided to the signal processing circuit 126.

It is noted that the optical navigation mechanism 110 can transition from the normal operation state 310 to a power saving state 210 based on whether the present signal is asserted or de-asserted as described in FIG. 2.

FIG. 4 is a block diagram illustrating a sensor array 400 with two different types of sensors according to a one embodiment of the invention. The sensor array 400 includes an optical sensor array 410 and a non-optical sensor array 430. The optical sensor array 410 includes one or more optical sensors, such as optical sensors 411-420, 422, 424 that may be arranged in rows and columns. It is noted that the number of rows and columns and the predetermined configuration of the optical sensors 411-420, 422, 424 in the array 410 may be adjusted or tailored to suit the particular requirements of a particular application. For example, the shape of the optical sensor array 410 may be a square as shown, a rectangle, or other geometric shape. Similarly, the shape of the optical sensors may be a square as shown, a rectangle, or other geometric shape.

The non-optical sensor array 430 includes one or more non-optical sensors, such as non-optical sensors 432, 434, 436, 438 that may be arranged in rows and columns. It is noted that the number of rows and columns and the predetermined configuration of the non-optical sensors 432, 434, 436, 438 in the array 430 may be adjusted or tailored to suit the particular requirements of a particular application. For example, the shape of the non-optical sensor array 430 may be a square as shown, a rectangle, or other geometric shape. Similarly, the shape of the non-optical sensors may be a square as shown, a rectangle, or other geometric shape.

It is noted that in an alternative embodiment, the non-optical sensor array 430 is arranged in a manner that is separated by a predetermined distance or space from the optical sensory array 410. Moreover, although the size of the non-optical sensors are shown to be substantially the same size of the optical sensors, it is noted that the size of the non-optical sensors may be smaller or larger than the size of the optical sensors. Furthermore, the geometric shape of the non-optical sensors may be different from the shape of the optical sensors.

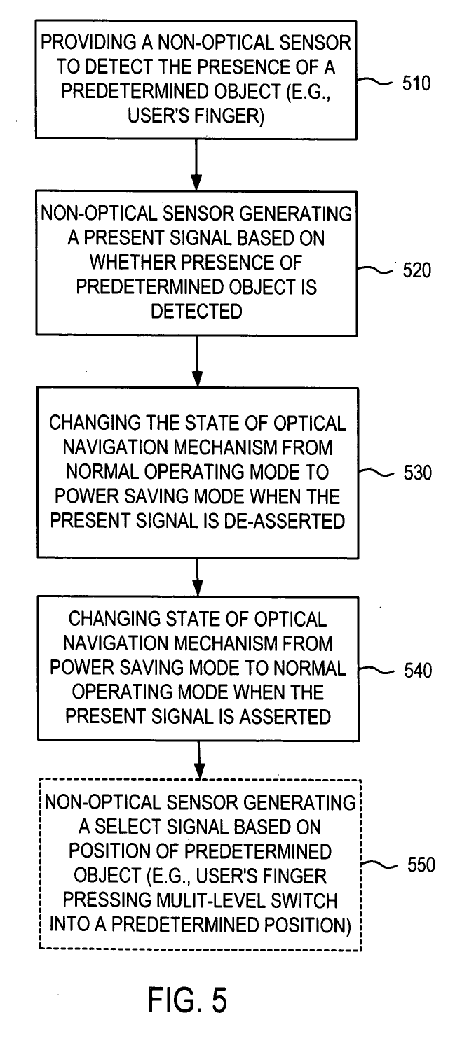

FIG. 5 is a flowchart illustrating a method performed by the presence detector according to a one embodiment of the invention. In step 510, at least one non-optical sensor (e.g., an array of non-optical sensors) is provided to detect the presence of a predetermined object (e.g., user's finger). In step 520, the non-optical sensor generates a present signal based on whether presence of predetermined object is detected. In step 530, the state of optical navigation mechanism is changed from normal operating mode to power saving mode when the present signal is de-asserted. In step 540, the state of optical navigation mechanism is changed from power saving mode to normal operating mode when the present signal is asserted.

In step 550, the non-optical sensor optionally generates a select signal based on position of a predetermined object (e.g., a user's finger). For example, when the non-optical sensor is implemented with a multi-level switch that includes a first position, a second position, and a third position, the different positions can be assigned to represent a particular signal. A first position of the switch can indicate that a user is not present. A second position can indicate that a user is present (e.g., user's finger has been detected). A third position can indicate that a user has biased the switch into the third position to indicate that the user wants to select or click a particular function. In this case, the second position of the switch generates a present signal that indicates that the presence of a predetermined object (e.g., a user's finger) is detected, and a third position of the switch generates a select signal that indicates the user has selected a particular function.

FIG. 6 illustrates a non-optical sensor 610 according to one embodiment of the invention. The non-optical sensor 610 may be implemented with a two position switch that includes a first position and a second position. The presence or absence of an object 604 (e.g., user finger or stylus) selects whether the switch 610 electrically couples the present signal 624 to a logic high signal 614 or to a logic low signal 618. When the switch 610 is in the first position, the switch 610 generates a de-asserted present signal 624 (e.g., the sensor 610 de-asserts the present signal), indicating that the presence of a predetermined object 604 (e.g., user finger or stylus) has not been detected. When in the second position, the sensor 610 generates an asserted present signal 624 (e.g., the sensor 610 asserts the present signal), indicating that the presence of the predetermined object 604 has been detected.

FIG. 7 illustrates a non-optical sensor 710 according to another embodiment of the invention. The non-optical sensor 710 may be implemented with a multi-level switch that includes a first position, a second position, and a third position. When in the first position, the sensor 710 generates a de-asserted present signal (e.g., the sensor 710 causes the present signal to be coupled to a logic low level 706), indicating that the presence of a predetermined object has not been detected. When in the second position, the sensor 710 generates an asserted present signal (e.g., the sensor 710 asserts or causes the present signal to be coupled to a logic high level 708), indicating that the presence of a predetermined object has not been detected. When in the third position, the sensor 710 generates an asserted select signal (e.g., the sensor 710 asserts or causes the select signal to be a logic high level 708), indicating that the user has selected or “clicked” a particular function. When in the first position and the second position, the switch 710 couples the select signal 718 to the logic low level 706. The select signal 718 can be utilized to select a function provided by the portable electronic device 100.

FIG. 8 illustrates a non-optical sensor 820 integrated with a button 810 of an electronic device according to a one embodiment of the invention. The button 810 can be a numeral button on a handset, for example. The optical sensor and non-optical (N/O) sensor array 820 can be physically integrated with the button 810. The button 810 can be utilized to input an assigned number as in the case of an ordinary button. However, when the optical sensor and non-optical (N/O) sensor array 820 are integrated with the button according to the invention, the button 810 can be utilized to detect the presence or absence of a predetermined object for power saving purposes, to select a particular function, or both of these purposes.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method of saving power for an optical navigation mechanism that includes a power-saving mode and a normal operating mode comprising:
utilizing a non-optical sensor to detect the presence or absence of a predetermined object; wherein the non-optical sensor generates a present signal; and
selectively turning the optical navigation mechanism from a power-saving mode to a normal operating mode and from a normal operating mode to a power-saving mode based on the present signal.

2. The method of claim 1 wherein selectively changing the optical navigation mechanism from a power-saving mode to a normal operating mode and from a normal operating mode to a power-saving mode includes changing the optical navigation mechanism from a power-saving mode to a normal operating mode when the present signal is asserted.

3. The method of claim 1 wherein selectively changing the optical navigation mechanism from a power-saving mode to a normal operating mode and from a normal operating mode to a power-saving mode includes changing the optical navigation mechanism from a normal operating mode to a power-saving mode to when the present signal is de-asserted.

4. An optical navigation circuit with integrated non-optical sensor comprising:
at least one optical sensor that detects light and converts the detected light into a corresponding electric signal;
an optical navigation mechanism that employs the output of the optical sensor to provide a user-controllable cursor navigation; wherein the optical navigation mechanism has a power saving state and a operation state;
a non-optical sensor that detects that presence or absence of an object in the vicinity of the non-optical sensor; and
a power saving mechanism coupled to the non-optical sensor that receives a present signal and responsive thereto selectively transitions or enables the optical navigation mechanism from the power saving state to the operation state and from the operation state to a power saving state.

5. The circuit of claim 4 wherein the non-optical sensor generates a second output signal; the apparatus further comprising:
a select mechanism coupled to the non-optical sensor that receives the second output signal and provides the second output signal to the optical navigation mechanism; wherein the optical navigation mechanism utilizes the second output signal to determine whether a select function has been activated by a user.

6. The circuit of claim 4 wherein the circuit is utilized in a mobile electronic device.

7. A mobile electronic apparatus comprising:
at least one optical sensor that detects light and converts the detected light into a corresponding electric signal;
an optical navigation mechanism that employs the output of the optical sensor to provide a user-controllable cursor navigation; wherein the optical navigation mechanism has a power saving state and a operation state;
a non-optical sensor that detects that presence or absence of an object in the vicinity of the non-optical sensor;
a power saving mechanism coupled to the non-optical sensor that receives a present signal and responsive thereto selectively transitions or enables the optical navigation mechanism from the power saving state to the operation state and from the operation state to a power saving state.

8. The mobile electronic apparatus of claim 7 wherein the non-optical sensor generates a second output signal; the apparatus further comprising:
a select mechanism coupled to the non-optical sensor that receives the second output signal and provides the second output signal to the optical navigation mechanism; wherein the optical navigation mechanism utilizes the second output signal to determine whether a select function has been activated by a user.
